(19) United States
(12) Patent Application Publication
(10) Pub. No.: US 2016/0165845 A1
(43) Pub. Date: Jun. 16, 2016

(54) Treat Dispensing Pet Toy

(71) Applicant: The KONG Company, LLC, Golden, CO (US)

(72) Inventor: John James Stone, Golden, CO (US)

(21) Appl. No.: 14/566,969

(22) Filed: Dec. 11, 2014

(51) Int. Cl. A01K 15/02; A01K 29/00; A01K 5/01

(52) U.S. Cl. CPC A01K 15/025; A01K 5/0114; A01K 29/00

(57) ABSTRACT

A treat dispensing device and method are provided that enables treats to be dispensed for multiple different types of treats simultaneously, but at selected different rates. The treat dispensing device has a plurality of treat dispensing openings or holes, and a plurality of chambers within the device separated by respective internal partitions. Each chamber may be loaded with desired types of treats. The size, shape, and number of treat dispensing openings may differ between openings that communicate with respective chambers. The different sized and shaped treat dispensing openings, as well as the number of openings in the device, provide different levels of difficulty for treat extraction.

### FIELD OF THE INVENTION

The invention relates to pet toys that have the capability to dispense food or treats, and more particularly, to a treat dispensing device and method in which different types and sizes of food/treats can be simultaneously dispensed from the toy, and dispensing may occur at different rates.

### BACKGROUND OF THE INVENTION

Interactive pet toys have become more popular in recent times. Interactive pet toys can be defined as those that encourage an animal to interact with the toy because of some type of stimulus associated with the toy. The stimulus can take many forms, such as food/treats, smell, sound, the shape or resiliency of the toy, and others. Animal behaviorists confirm that many therapeutic benefits are provided to a pet by an interactive pet toy. For example, chew toys with treats provide both mastication and extended overall physical preoccupation of the animal. Toys with edible treats are known to help remediate separation anxiety in some pets in which an animal may be less prone to engage in negative behavior since the animal is occupied over a longer period of time, and at greater occupation intensity.

There are a significant number of U.S. patent references that disclose treat dispensing pet toys or pet toys with frictionally held treats. One example of a reference disclosing a pet toy with treats includes U.S. Pat. No. 7,555,997. This reference describes an exterior feature for holding treats by a peripheral lip that surrounds and overlaps a corresponding peripheral edge of a first treat, and an interior open space that may be used to hold additional treats. The first treat blocks access to the interior open space.

Another reference disclosing a pet toy with treats is the U.S. Pat. No. 7,500,450. This reference teaches a toy with a hollow interior, a first edible treat that blocks access to the interior, and a second edible treat that interlocks with the first edible treat, the second edible treat extending into the interior of the toy. Additional treats may be placed within the hollow interior.

Yet another reference disclosing pet toys with treats is the U.S. Pat. No. 6,470,830. This reference describes a toy with a trapper cavity or slot to receive a treat. An adjacent biased cavity forms a biasing member between the trapper cavity and slot. Opposing walls of the trapper cavity clamp against surfaces of the treat inserted through the cavity.

Yet another reference in the field of pet toys with integral treats is the U.S. Pat. No. 5,832,877. This reference discloses a pet toy with a longitudinal panel, and first and second lips formed along opposite respective edges of the panel. The edges are folded over to form overlapping areas that serve as receptacles to receive treats.

Yet another reference that discloses a pet toy incorporating treats is the U.S. Pat. No. 6,129,053. This reference teaches a pet toy having an outer surface with one or more recesses for holding treats. The recesses may be of varying depths and shapes to receive different types of treats. Some of the recesses may extend completely through the sidewall of the toy.

One example of an animal food dispenser includes the invention disclosed in U.S. Pat. No. 6,526,912. This reference more specifically discloses a dispenser having a base portion and an upper portion defined by at least one wall enclosing a container cavity. An opening is formed in the upper portion to access the container cavity. A weighted body is fixed to the base of the dispenser, and provides a means for returning the dispenser to an upright position after the dispenser has been tipped or moved by the animal. The dispenser can be moved on a surface in an oscillating and/or sliding motion by the animal for dispensing a unit from the opening.

Despite the number of references disclosing such pet toys, there is still a need to provide a treat dispensing device for pets that can occupy an animal over a longer period of time. There is also an unmet need to provide a device that is capable of dispensing multiple different types of treats and at different dispensing rates within the same toy. There is also an unmet need to provide a device that can extend and intensify an animal's interaction with the pet toy based on behavior of the animal as the animal interacts with the toy. Finally, there is a continuing need to provide the aforementioned attributes in a pet toy that maintains a structurally simple yet reliable construction.

### SUMMARY OF THE INVENTION

According to the invention, a treat or food dispensing device and method are provided that allows treats/food to be dispensed for multiple different types of treats simultaneously, and at selected different rates. The different sized and shaped treat dispensing openings, as well as the number of openings in the device, provide different levels of difficulty for treat extraction. The word “treat” hereinafter is meant to include all animal foodstuffs that can be consumed by an animal. Treats make take various forms such as uniformly sized nuggets, or the treats may be irregularly sized and shaped.

According to the device of the invention, a treat dispensing device has a body of a desired shape, a plurality of treat dispensing openings or holes, and a plurality of internal chambers separated by respective internal partitions or dividers. Each of the internal chambers may be loaded with a desired type of treat. The size and shape of the treat dispensing openings differ between openings that communicate with respective internal chambers. Accordingly, each of the chambers and the corresponding treat dispensing openings can be conceptually viewed as separate and distinct treat dispensing elements or units incorporated within a single pet toy.

In a preferred embodiment of the invention, it includes multiple dispensing units that are joined together to form a single pet toy. According to one aspect of this embodiment, each of the dispensing units can be molded structures that are then joined to one another by high-frequency welding. The final shape of the pet toy comprising the multiple units can be any number of desired shapes to include squares, triangles, circles, donut shaped, and others. The individual shape of each of the dispensing units forms a part of the overall shape of the pet toy. Accordingly from an exterior view of the pet toy, it appears to simply be a single unit.

The structure of the pet toy may be further described as including a body with an exterior surface, and interior surface, and a sidewall defining a thickness of the material used for the pet toy. The treat dispensing openings are dispersed throughout the pet toy, with at least one pet dispensing opening for each of the dispensing units. The openings among each of the dispensing units may have different shapes and sizes such that treats are dispensed at different rates through the openings, depending upon the extent to which the toy is moved by the animal. For example, some of the openings may be larger and therefore easier for treats to be dispensed, while other openings may be smaller and therefore more difficult for treats to be dispensed. The dispensing rate can also be adjusted by the number of openings provided per dispensing unit.

The material used for the pet toy may elastomeric, semi-rigid, or rigid. For some animals, it may be advantageous for the pet toy to be flexible and elastomeric, thereby encouraging the animal to chew on the toy. For other animals, it may be advantageous for the pet toy to be more rigid so that dispensing treats is primarily achieved by movement and rotation of the pet toy to cause treats to pass through the treat dispensing openings.

The pet toy of the invention has a number of purposes. One purpose is for the pet toy to serve as a treat dispenser for dispensing treats associated with a normal meal of the animal. Accordingly, the invention in this purpose serves to slow down the feeding activity of the animal. Another purpose of the pet toy is to serve as a more natural feeding and foraging experience for the animal in which consumption is achieved over a greater period of time with significantly greater effort than simply feeding the animal from a traditional bowl. Another purpose of the pet toy is to encourage exercise and activity of the animal that is not naturally associated with a scheduled feeding of the animal.

According to another aspect of the invention, a method is provided for dispensing treats. The method is achieved with a dispensing device having a number of variables to enhance the number of options for providing treats. One variable is the size of the treat openings in the device. Another variable is the number of treat openings in the device. Another variable is the shaped of the treat openings in the device. Yet another variable is the number and size of treat openings per dispensing unit. Other variables include the sizes and shapes of treats that are loaded in the pet toy and held within the respective chambers of the dispensing units. One can appreciate from the multiple foregoing variables that the method of invention can be specifically tailored to dispense the number and type of treats over a desired period of time. The method can also be tailored to dispense treats with a desired amount of effort from the animal.

In one aspect of the invention, it may be considered a treat dispensing pet toy comprising: (i) a body defining a shape of the toy, and the pet toy having a hollow interior space; (ii) a plurality of dispensing units incorporated in said body, each dispensing unit comprising at least one divider disposed within the hollow interior space of the pet toy, and each said divider having an outer peripheral surface that contacts an interior surface of the pet toy thereby creating a dispensing chamber within said pet toy; and (iii) a plurality of treat dispensing openings formed in each of said dispensing units for dispensing treats loaded in respective dispensing chambers.

In another aspect of the invention, it may be considered in combination, a treat dispensing pet toy and treats loaded within the pet toy, comprising: (i) a body defining a shape of the pet toy; (ii) a plurality of dispensing units incorporated in said body, each dispensing unit comprising at least one divider disposed within an interior of the pet toy, said divider having an outer peripheral surface that contacts an interior surface of the pet toy, thereby creating a corresponding dispensing chamber within said pet toy; (iii) at least one treat dispensing opening formed in each of said dispensing units; and (iv) a plurality of treats loaded in at least one of the dispensing chambers, and dispensed by movement of the pet toy to cause at least some of said treats to pass through said treat dispensing openings from within a corresponding dispensing chamber.

In yet another aspect of the invention, it may be considered a method of dispensing treats from a pet toy, comprising: (a) providing a pet toy comprising: (i) a body defining a shape of the pet toy; (ii) a plurality of dispensing units incorporated in said body, each dispensing unit comprising at least one divider disposed within an interior of the pet toy, said divider having an outer peripheral surface that contacts an interior surface of the pet toy, thereby creating a corresponding dispensing chamber within said pet toy; and (iii) at least one treat dispensing opening formed in each of said dispensing units; (b) loading a plurality of treats in at least one of the dispensing chambers; and (c) moving the pet toy to cause at least some of said treats to pass through said treat dispensing openings from within a corresponding dispensing chamber.

Other features and advantages of the invention will become apparent from a review of the following detailed description, taken in conjunction with the drawings.

### BRIEF DESCRIPTION OF THE DRAWINGS

FIG. 1 is a perspective view of a first preferred embodiment of the pet toy invention;

FIG. 2 is another perspective view of FIG. 1 showing interior details of the pet toy including multiple chambers created by interior partitions or dividers;

FIG. 3 is a perspective view of a second preferred embodiment of the pet toy invention;

FIG. 4 is another perspective view of FIG. 3 showing interior details of the pet toy including multiple chambers created by interior partitions;

FIG. 5 is a perspective view of a third preferred embodiment of the pet toy invention;

FIG. 6 is another perspective view of FIG. 5 showing interior details of the pet toy including multiple chambers created by interior partitions;

FIG. 7 is a perspective view of a fourth preferred embodiment of the pet toy invention;

FIG. 8 is another perspective view of FIG. 7 showing interior details of the pet toy including multiple chambers created by interior partitions;

FIG. 9 is a perspective view of a fifth preferred embodiment of the pet toy invention; and

FIG. 10 is another perspective view of FIG. 9 showing interior details of the pet toy including multiple chambers created by interior partitions.

### DETAILED DESCRIPTION

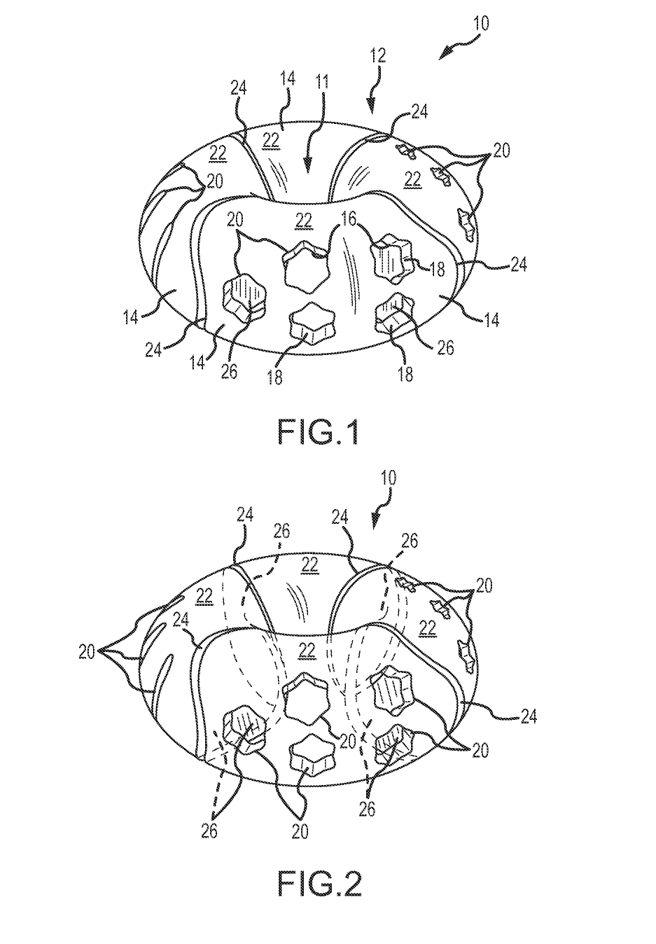

Referring to FIG. 1, a treat dispensing pet toy 10 is illustrated in a first embodiment. The shape of the pet toy in this embodiment is depicted as donut shaped with a central opening 11 and a body 12 that surrounds the central opening 11. The outer surface 14 has a plurality of treat dispensing openings or holes 20. A sidewall 18 of the pet toy is defined as the thickness of the material used for the pet toy as measured between the outer surface 14 and the interior surface 16.

In one preferred embodiment, the device is made from a plurality of separate dispensing units for dispensing segments. In FIG. 1, the device includes four distinct dispensing units 22 attached to one another to form the donut shaped presentation. Referring also to FIG. 2, each of the dispensing units has respective partitions or dividers 26 that are disposed internally within the device when assembled. The peripheral or outer surfaces of the partitions contact the interior surface 16 of the pet toy such that each of the dispensing units has a chamber defining an interior volume of a portion of the pet toy. The dispensing units may have a shared divider as between adjacent dispensing units, or each dispensing unit may have a pair of spaced dividers in which dividers between adjacent dispensing units may be joined to one another when the device is assembled.

Although the volumes of the dispensing chambers in FIG. 1 may be illustrated as approximately the same, it is also contemplated that the dispensing units 22 can be of different sizes, thereby providing different sized dispensing chambers. A few exemplary treats T are shown loaded in one of the dispensing chambers.

The peripheral or outer surfaces of the partitions 26 are shaped to enable assembly of the device in a desired configuration. Accordingly for the embodiment of FIG. 1, the peripheral surfaces are curved to enable assembly of a unitary donut shaped device. One method of assembling the dispensing units 22 may include high frequency welding of the dispensing units along weld or joint lines 24.

The figures are intended to illustrate a plurality of different treat dispensing openings 20 in which the openings 20 can be differentiated from one another by size, shape, and the density/number of openings per dispensing unit 22. In this way, the device is capable of dispensing different types of treats at selected different rates. The device is also capable of dispensing treats at selected different rates depending upon the extent to which the animal is able to move the device during play and feeding. For example, for older less active dogs, an owner may wish to load the device so that treats are more easily dispensed. For younger more active dogs, an owner may wish to load the device so treats are more difficult to be dispensed. The different sized and shaped treat dispensing openings, as well as the number of openings in the device, provide different levels of difficulty for treat extraction.

With respect to variable rate dispensing, an owner also has options for varying dispensing treats for routine feeding. For example, the user may wish for one of the dispensing units to dispense treats such as dog food, in order to feed an animal according to a scheduled meal for the animal. The user may wish to load another one of the dispensing units with dog snacks that are dispensed at a much slower rate, and require the animal to more vigorously roll, flip, or otherwise displace the toy in order to dispense the treats. The owner may wish to load yet another one of the dispensing units with a combination of dog food and snacks, and to be dispensed at a rate that is between the first and second dispensing units. It should be appreciated that the foregoing examples demonstrate the diverse capabilities of the pet toy in terms of dispensing many different types of treats for many purposes.

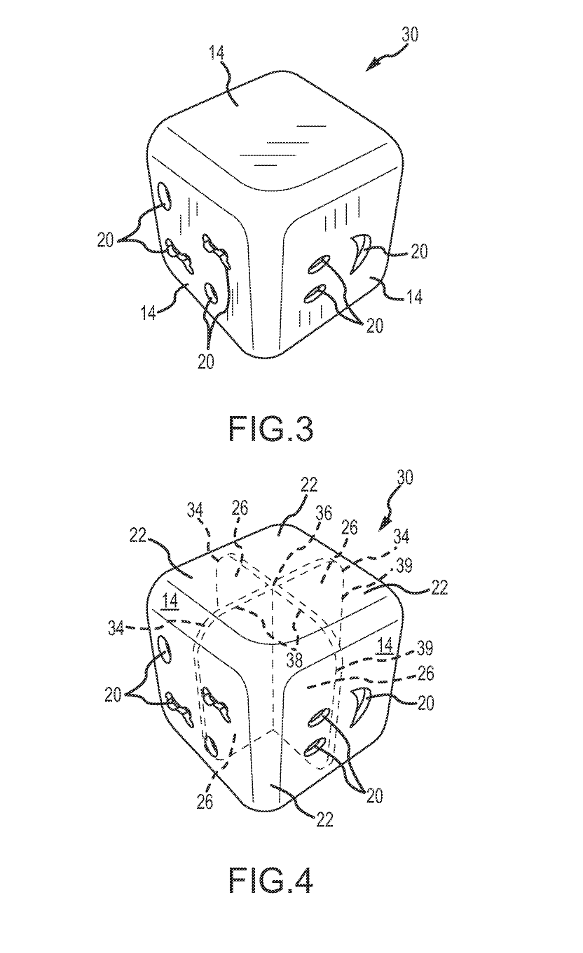

FIG. 3 illustrates another preferred embodiment in which a pet toy 30 has a different shape. As shown, the pet toy 30 of FIG. 3 is cube shaped. The same reference numbers used in this embodiment correspond to the same structural elements from the first embodiment. Referring to FIG. 4, four distinct dispensing units are provided in which the internal partitions 26 are configured to accommodate the four distinct dispensing units. As with the embodiment of FIGS. 1 and 2, the embodiment of FIGS. 3 and 4 are intended to represent dispensing openings 20 that have each have selected shapes, sizes, and number of openings per dispensing unit. The particular configuration of the partitions 26 shown in FIG. 4 also illustrate the partitions configured so that the cube shaped toy 30 incorporates the four distinct dispensing units. Accordingly, there are four internal partitions, each having curved peripheral surfaces 34, respective horizontal sides 38, and respective vertical sides 39. The partitions 26 are joined to one another along a vertical intersection line or axis 36. The vertical sides 39 contact the interior surface of the toy such that the dispensing units have respective dispensing chambers that are separated from one another. Again, one should appreciate the number of options provided to a pet owner with respect to dispensing treats.

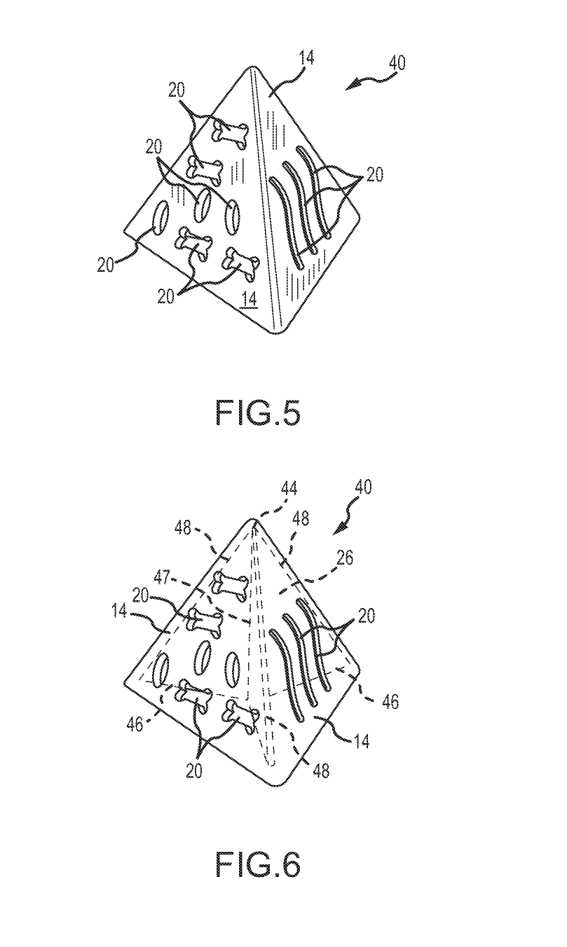

Referring to FIGS. 5 and 6, another preferred embodiment is illustrated in which the pet toy 40 has a pyramid shape. The same reference numbers used in this embodiment correspond to the same structural elements from the prior embodiments. Referring to FIG. 6, the internal partitions 26 are configured in triangular shapes. Accordingly, each of the partitions has a base leg 46, a vertical leg 47, and a hypotenuse 48. The partitions 26 are joined at their upper ends at apex 44. The hypotenuses 48 of the partitions 26 contact the interior surface of the toy such that the dispensing units have respective separate dispensing chambers.

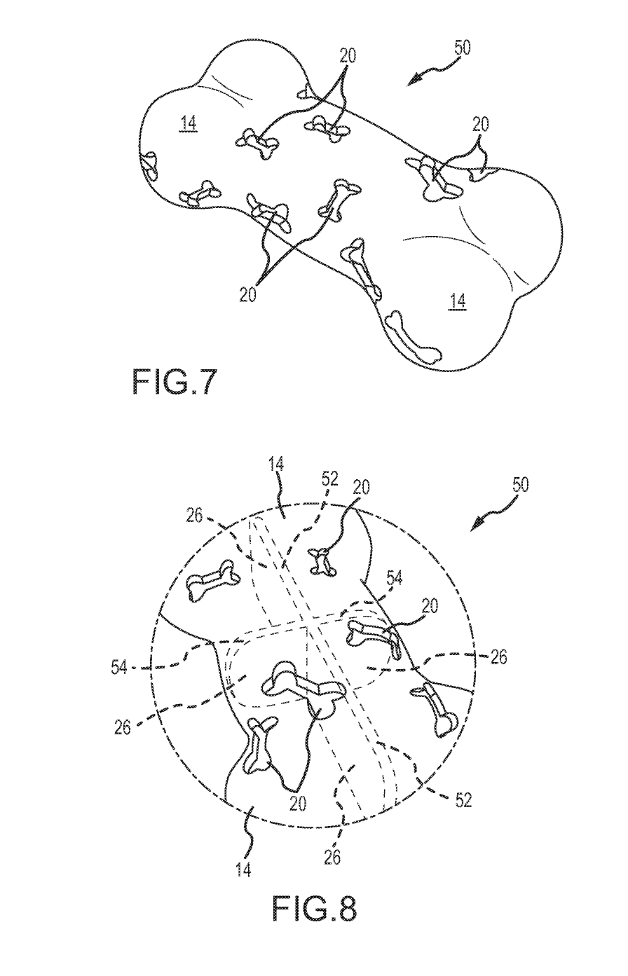

Referring to FIGS. 7 and 8, yet another preferred embodiment is illustrated in which the pet toy 50 has a bone shape. Again, the same reference numbers used in this embodiment correspond to the same structural elements from the prior embodiments. The partitions 26 in this embodiment may be characterized as including two longitudinal partitions 26 that extend along the long axis or length of the pet toy 50, and two shorter transverse partitions 26 that extend substantially perpendicular to the orientation of the longitudinal partitions 26. The partitions 26 are joined to one another along perpendicular axis or line 58. The transverse partitions 26 have outer or peripheral surfaces 54 that continuously contact the facing interior surface of the pet toy, and the longitudinal partitions are also shaped with outer or peripheral surfaces 52 that continuously contact the facing interior surface of the pet toy 50, thereby creating four separated dispensing chambers within the pet toy.

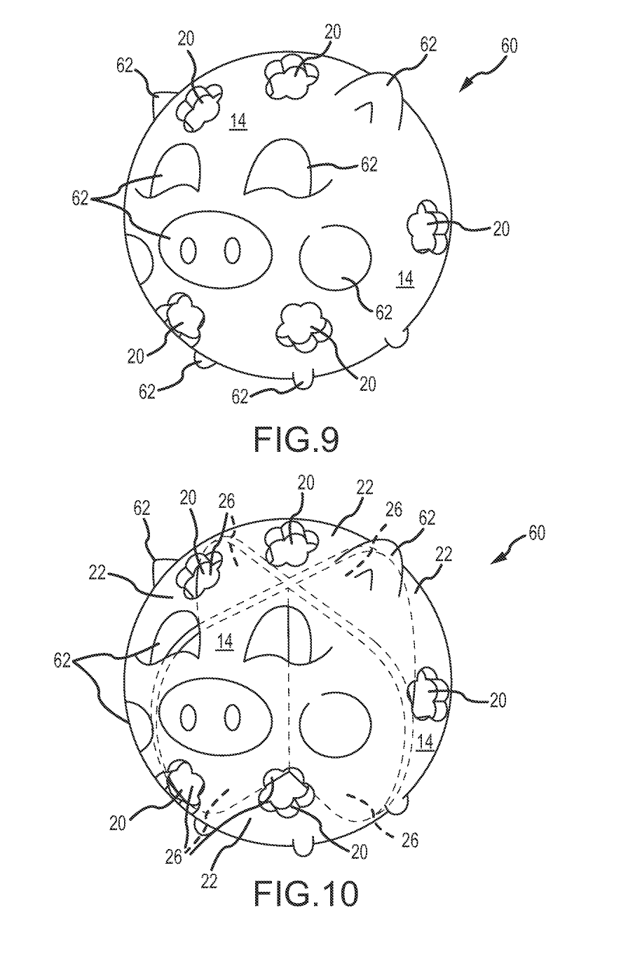

Referring to FIGS. 9 and 10, yet another preferred embodiment is illustrated in which the pet toy 60 has an animal shape, namely, a pig. Again, the same reference numbers used in this embodiment correspond to the same structural elements illustrated in the prior embodiments. The partitions 26 in this embodiment are half circular shaped in order to match the corresponding round shape of the pet toy 60. Accordingly, each of the partitions 26 have outer peripheral surfaces 64 that are curved, and which make continuous contact with the facing interior surface of the pet toy thereby creating four distinct and separated dispensing chambers within the pet toy. The pet toy of FIGS. 9 and 10 are also shown with a number of exterior features 62 so that the pet toy depicts the particular animal. As shown, these exterior features 62 may include a nose, eyes, ears, and legs, etc.

According to a method of the invention, a pet toy is provided to dispense treats. The pet toy includes separate dispensing units that enable different types of treats to be dispensed at different rates. The dispensing units have treat dispensing openings of different sizes, shapes, and varying numbers of openings per dispensing units. A pet owner loads selected types of treats in the pet toy by inserting treats through the openings in the dispense units. The owner chooses a type(s) of treat to be dispensed at a selected rate(s). The actual rate of dispense may correspond to attributes of the animal, such as how active the animal is in terms of its play with the toy, in which greater movement of the pet toy will result in a generally higher rate of dispense. The owner may take this factor into consideration when selecting treat(s) and the loading of treats in selected dispensing units. The toy is given to the animal so that the animal may interact with the toy to dispense treats.

There are number of advantages to the invention. The pet toy includes a plurality of distinct dispensing units that provide a pet owner with multiple options for dispensing treats. The pet toy may be used as a feeder for meals, a dispenser for snacks, or a combination of both. Because multiple dispensing units are provided, the pet toy may be used as both a feeder and snack dispenser, simultaneously. The different sized and shaped treat dispensing openings, as well as the number of openings in the device, provide different levels of difficulty for treat extraction.

What is claimed is:

1. A treat dispensing pet toy, comprising:
a body defining a shape of the toy, and a hollow interior space within said body;
a plurality of dispensing units incorporated in said body, each dispensing unit comprising at least one divider disposed within the hollow interior space, and each said divider having an outer peripheral surface that contacts an interior surface of the pet toy thereby creating a dispensing chamber within said pet toy; and
a plurality of treat dispensing openings formed in each of said dispensing units for dispensing treats loaded in respective dispensing chambers.

2. A treat dispensing pet toy, as claimed in claim 1, wherein:
treat dispensing openings as between said dispensing units have different sizes.

3. A treat dispensing pet toy, as claimed in claim 1, wherein:
treat dispensing openings as between said dispensing units have different shapes.

4. A treat dispensing pet toy, as claimed in claim 1, wherein:
treat dispensing openings as between said dispensing units have a different number of openings per dispensing unit.

5. A treat dispensing pet toy, as claimed in claim 1, wherein:
the hollow interior space is divided into substantially equal volumes by said dividers of said dispensing units.

6. A treat dispensing pet toy, as claimed in claim 1, wherein:
the hollow interior space is divided into substantially unequal volumes by said dividers of said dispensing units.

7. In combination, a treat dispensing pet toy and treats loaded within the pet toy, comprising:
a body defining a shape of the pet toy;
a plurality of dispensing units incorporated in said body, each dispensing unit comprising at least one divider disposed within an interior of the pet toy, said divider having an outer peripheral surface that contacts an interior surface of the pet toy, thereby creating a corresponding dispensing chamber within said pet toy;
at least one treat dispensing opening formed in each of said dispensing units; and
a plurality of treats loaded in at least one of the dispensing chambers, and dispensed by movement of the pet toy to cause at least some of said treats to pass through said treat dispensing openings from within a corresponding dispensing chamber.

8. The combination, as claimed in claim 7, wherein:
treat dispensing openings between said dispensing units have different sizes.

9. The combination, as claimed in claim 7, wherein:
treat dispensing openings between said dispensing units have different shapes.

10. The combination, as claimed in claim 7, wherein:
treat dispensing openings between said dispensing units have a different number of openings per dispensing unit.

11. The combination, as claimed in claim 7, wherein:
said interior is divided into substantially equal volumes by said dividers of said dispensing units.

12. The combination as claimed in claim 7, wherein:
said interior is divided into substantially unequal volumes by said dividers of said dispensing units.

13. A method of dispensing treats from a pet toy, comprising:
providing a pet toy comprising: (i) a body defining a shape of the pet toy; (ii) a plurality of dispensing units incorporated in said body, each dispensing unit comprising at least one divider disposed within an interior of the pet toy, said divider having an outer peripheral surface that contacts an interior surface of the pet toy, thereby creating a corresponding dispensing chamber within said pet toy; and (iii) at least one treat dispensing opening formed in each of said dispensing units;
loading a plurality of treats in at least one of the dispensing chambers; and
moving the pet toy to cause at least some of said treats to pass through said treat dispensing openings from within a corresponding dispensing chamber.

14. The method, as claimed in claim 13, wherein:
treat dispensing openings between said dispensing units have different sizes.

15. The method, as claimed in claim 13, wherein:
treat dispensing openings between said dispensing units have different shapes.

16. The method, as claimed in claim 13, wherein:
treat dispensing openings between said dispensing units have a different number of openings per dispensing unit.

17. The method, as claimed in claim 13, wherein:
said interior is divided into substantially equal volumes by said dividers of said dispensing units.

18. The method as claimed in claim 13, wherein:
said interior is divided into substantially unequal volumes by said dividers of said dispensing units.

19. The method, as claimed in claim 13, wherein:
treats are dispensed at different rates as between similar sized treats loaded in different dispensing units.

20. The method, as claimed in claim 13, wherein:
treats are dispensed at different rates as between different treats loaded in different dispensing units.

21. The method, as claimed in claim 13, wherein:
treats are dispensed at different rates for different dispensing units based upon how vigorously the pet toy is moved over a period of time.

22. The method, as claimed in claim 13, wherein:
treats are simultaneously dispensed at different rates as between similar sized treats loaded in different dispensing units.

23. The method, as claimed in claim 13, wherein:
treats are simultaneously dispensed at different rates as between different treats loaded in different dispensing units.
